(19) United States
(12) Patent Application Publication
(10) Pub. No.: US 2004/0227981 A1
(43) Pub. Date: Nov. 18, 2004

(54) Image reading apparatus

(75) Inventors: Hiroshi Nishikawa, Toyokawa-shi (JP); Noritoshi Maruchi, Toyokawa-shi (JP); Motoki Takata, Toyohashi-shi (JP)

Correspondence Address: Barry E. Bretschneider, Morrison & Foerster LLP, Suite 300, 1650 Tysons Boulevard, McLean, VA, 22102, US

(73) Assignee: Konica Minolta Business Technologies, Inc., Chiyoda-ku (JP)

(21) Appl. No.: 10/787,235

(22) Filed: Feb. 27, 2004

(30) Foreign Application Priority Data
Feb. 24, 2003 (JP) 2003-045479

(51) Int. Cl. H04N 1/024; H04N 1/04

(52) U.S. Cl. 358/496; 358/498; 358/486

(57) ABSTRACT

A compact and maintenance-free image reading apparatus capable of preventing deterioration in image quality due to suspended foreign matter by being provided with a spacer that is mounted on a reading transparent member on a surface thereof opposite the side thereof at which a reading unit is disposed and at a position upstream from an original document reading position relative to an original document conveyance direction, wherein the spacer is configured such that height of a downstream end thereof relative to the original document conveyance direction decreases toward the downstream direction.

This application is based on Japanese Patent Application No. 2003-045479 filed in Japan on Feb. 24, 2003, the entire content of which is hereby incorporated by reference.

### BACKGROUND OF THE INVENTION

1. Field of the Invention

The present invention relates to an image reading apparatus mounted in a copier, scanner or the like, and more particularly to an image reading apparatus that uses the sheet-through method feed an original document while reading the images contained thereon.

2. Description of the Related Art

In the conventional art, as an image reading apparatus for a copier or the like, an apparatus that employs the sheet-through method in which an original document is fed forward using rollers or the like and is read as it passes the reading glass is known. In this image reading apparatus using the sheet-through method, it is easy for foreign matter such as glue, correction fluid or ballpoint-pen ink adhering to the original document to transfer onto the reading glass when the original document comes into contact therewith. This adhering foreign matter can subsequently cause image noise during reading of the image.

In response to this problem, a technology has been proposed whereby foreign matter is prevented from transferring onto the reading glass by eliminating contact between the original document and the reading glass (see Japanese Laid-Open Patent Application H9-307695, pp. 4-5, FIGS. 1-9). In this type of image reading apparatus, a spacer is placed at the ‘upstream’ side of the reading glass relative to the original document (the side from which the original document is fed). The spacer causes the original document to ‘float’ over the reading glass as it is being conveyed. In addition, a capture member having bumps and indentations or a sticky coating on the surface is disposed next to this spacer in order to capture foreign matter such as suspended dirt or dust (see Japanese Laid-Open Patent Application 2001-223832, pp. 4-5, FIGS. 3-6).

An image reading apparatus whereby the original document is prevented from coming into contact with the reading glass by mounting the reading glass at an angle relative to the original document conveyance path is also known (see Japanese Laid-Open Patent Application H11-146140, pp. 2-3, FIGS. 3-5). This application also describes a construction in which an ejection member such as a gap or a fan serves to eliminate foreign matter that has accumulated between the angled reading glass and the original document conveyance path.

However, in the various conventional image reading apparatuses described above, a capture member or ejection member is mounted in order to prevent suspended foreign matter from accumulating. Such a member is necessary because merely preventing the original document from coming into contact with the reading glass does not prevent other foreign matter such as paper particles from becoming generated and suspended therebetween. However, this capture member or ejection member entails the problem that it increases the size of the apparatus, as well as the problem that regular maintenance is required in order to eliminate the foreign matter that accumulates on the capture member or ejection member.

### OBJECT AND SUMMARY

An object of the present invention is to provide a compact, maintenance-free, improved image reading apparatus that eliminates the problems described above and prevents deterioration in image quality due to suspended foreign matter.

In order to achieve the above object, the image reading apparatus according to one aspect of the present invention includes a reading transparent member, a reading unit that reads through the reading transparent member the image on the original document that is being conveyed over the original document reading position of the reading transparent member, and a spacer that is mounted on the reading transparent member on the surface thereof opposite the side thereof at which the reading unit is disposed and at a position upstream from the original document reading position relative to the original document conveyance direction, and is configured such that the height of the downstream end thereof relative to the original document conveyance direction decreases toward the downstream direction.

According to the image reading apparatus of the present invention, an original document is read by the reading unit through the reading transparent member at the original document reading position. When this takes place, the surface of the reading transparent member opposite the side thereof at which the reading unit is disposed is the surface onto which the original document is conveyed, and if a spacer is mounted thereon, the original document is conveyed on top of the spacer. Because the spacer position is upstream relative to the original document conveyance direction, it causes the original document to be suspended above the reading transparent member at the original document reading position. Furthermore, because the end of the spacer decreases in height toward the downstream direction, the trailing edge of the original document passes very close to the end of the spacer. Therefore, the foreign matter suspended over the reading transparent member near the original document reading position is cleaned off by the trailing edge of the original document. As a result, a compact, maintenance-free image reading apparatus that prevents image quality deterioration due to suspended foreign matter can be achieved.

Furthermore, it is preferred in the image reading apparatus of the present invention that the spacer be configured such that its downstream end comprises a downward-sloping surface whereby the height thereof relative to the original document conveyance direction decreases toward the downstream direction.

If the spacer is configured in this fashion, the height of the end of the spacer decreases toward the downstream direction relative to the original document conveyance direction.

It is additionally preferred in the image reading apparatus of the present invention that the downstream end of the spacer relative to the original document conveyance direction have a stair-step configuration, and that the height of the steps decrease toward the original document conveyance direction.

Such a spacer configuration also ensures that the height of the end of the spacer decreases toward the downstream direction relative to the original document conveyance direction.

It is furthermore preferred in the image reading apparatus of the present invention that the spacer be composed of a lower surface member that comes into contact with the reading transparent member and an upper surface member that comes into contact with the original document during original document conveyance wherein such members are glued together to form a step configuration, and that the upper surface member be made of a material having a lower friction coefficient than the lower surface member. It is also preferred that the upper surface member be made of a material having better resistance to wear than the material comprising the lower surface member. It is even more preferred that the upper surface member be made of a material having both a lower friction coefficient and superior wear-resistance than the material of the lower surface member.

The original document slides on top of the upper surface member, which guides the original document in the conveyance direction. Accordingly, low coefficient of friction for the upper surface member is preferred because it allows the original document to slide smoothly thereon. Moreover, superior wear-resistance is preferred in order to ensure that the upper surface member will not become worn down by contact with original documents and will be able to accurately guide original documents in the conveyance direction.

Yet another object of the present invention is to provide a spacer that is used in an image reading apparatus having a reading transparent member and a reading unit that reads through the reading transparent member the image on an original document being conveyed over the original document reading position of the reading transparent member, wherein said spacer is mounted on the reading transparent member on the surface thereof opposite the side thereof at which the reading unit is disposed and at a position upstream from the original document reading position relative to the original document conveyance direction, and is configured with a sloping surface such that the downstream end thereof relative to the original document conveyance direction decreases in height downward toward the downstream direction.

### BRIEF DESCRIPTION OF THE DRAWINGS

These and other objects and features of the present invention will become clear from the following description taken in conjunction with the preferred embodiments thereof with reference to the accompanying drawings, in which,

FIG. 1 is a drawing showing the basic construction of the image reading apparatus pertaining to a first embodiment;

FIG. 2 is a cross-sectional drawing of a spacer pertaining to the first embodiment;

FIG. 3 is an explanatory drawing showing the trajectory of the trailing edge of the original document when a conventional spacer is used;

FIG. 4 is a cross-sectional drawing of a spacer pertaining to a second embodiment;

FIG. 5 is a cross-sectional drawing of a spacer pertaining to a third embodiment; and

FIG. 6 is an enlarged cross-sectional drawing of the spacer pertaining to the third embodiment.

### DETAILED DESCRIPTION OF THE PREFERRED EMBODIMENTS

[First Embodiment]

A first embodiment of the present invention will be described in detail below with reference to the drawings. This embodiment is an image reading apparatus that is mounted in an image forming apparatus such as a copier.

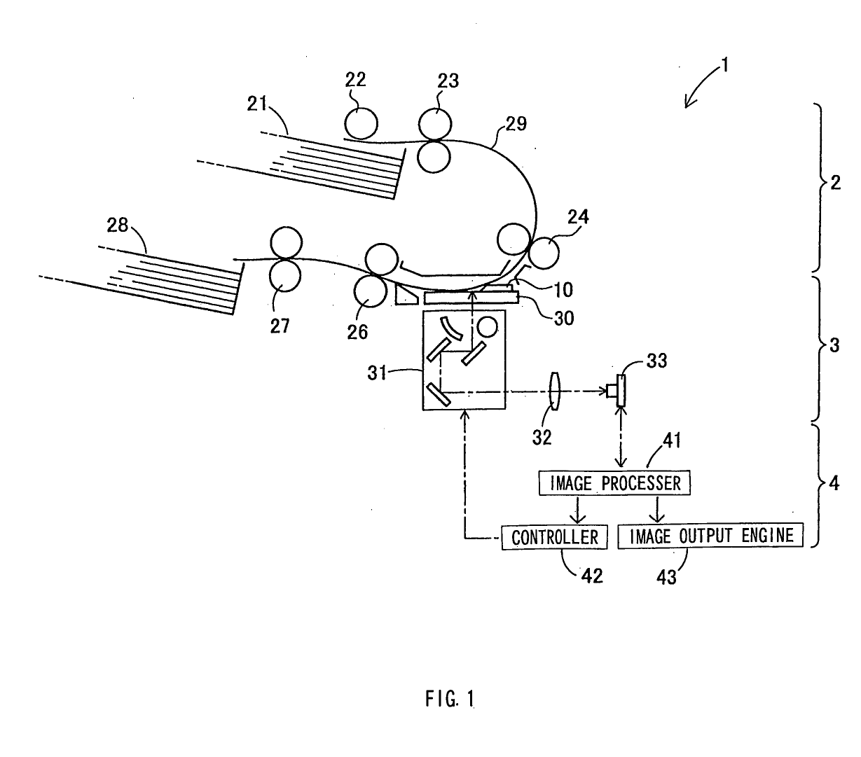

The image forming apparatus 1 in which the image reading apparatus 3 of this embodiment is mounted has in addition to the image reading apparatus 3 an original document conveyance unit 2 and an image processing/formation unit 4, as shown in the basic construction drawing of FIG. 1. The original document conveyance unit 2 includes an original document stacking tray 21, a pickup roller 22, paper feed rollers 23, first conveyance rollers 24, second conveyance rollers 26, ejection rollers 27 and an original document ejection tray 28. The original document is conveyed along the original document conveyance path 29 by these components.

The original document conveyance unit 2 has a construction essentially identical to that used in the conventional art. The original document stacking tray 21 holds multiple sheets of an original document. The pickup roller 22 lifts and separates the topmost sheet from the multiple original document sheets disposed on the original document stacking tray 21. The paper feed rollers 23, the first conveyance rollers 24 and the second conveyance rollers 26 work together to convey the original document in a prescribed direction. The ejection rollers 27 eject the conveyed original document to the original document ejection tray 28. The original document ejection tray 28 is the location at which the read and ejected original documents are collected and stored.

The image reading apparatus 3 includes a reading glass 30 to which the spacer 10 is mounted, a reading unit 31, a lens 32 and a CCD sensor 33. The reading glass 30 is a transparent member, and the original document that passes over the top surface thereof can be read through the underside surface thereof. Light emitting devices are contained in the reading unit 31, and light emitted from these devices strikes the original document that passes over the reading glass 30. The reflected light is guided to the CCD sensor 33 via the lens 32. The CCD sensor 33 detects the guided reflected light and obtains image data regarding the original document from the results of this detection.

The spacer 10 is disposed on the reading glass 30 at the right side thereof in FIG. 1. The image reading position at which the reading unit 31 reads the original document is located somewhat to the left of the spacer 10 in FIG. 1. Here, because the original document is conveyed from left to right over the reading glass 30 in the drawing, the position of the spacer 10 is upstream from the original document reading position in terms of the direction of original document conveyance. Due to the existence of the spacer 10, part of the reading glass 30 comes into contact with the original document while another part of the reading glass 30 does not come into contact the original document. The original document reading position is found within the area of the reading glass 30 that does not come into contact with the original document. The configuration of the spacer 10 and the original document reading position will be described in detail below.

The image processing/formation unit 4 is a component that forms appropriate output images from the image data that has been read. The image processing/formation unit 4 includes an image processor 41, a controller 42 and an image output engine 43. The image processor 41 is a component that outputs operation instructions to the CCD sensor 33 and the controller 42, processes read image data and creates image data suitable for output image formation. The controller 42 is a component that controls the image reading apparatus 3 in accordance with instructions from the image processor 41. The image output engine 43 is a component that forms output images from image data created via the processing by the image processor 41.

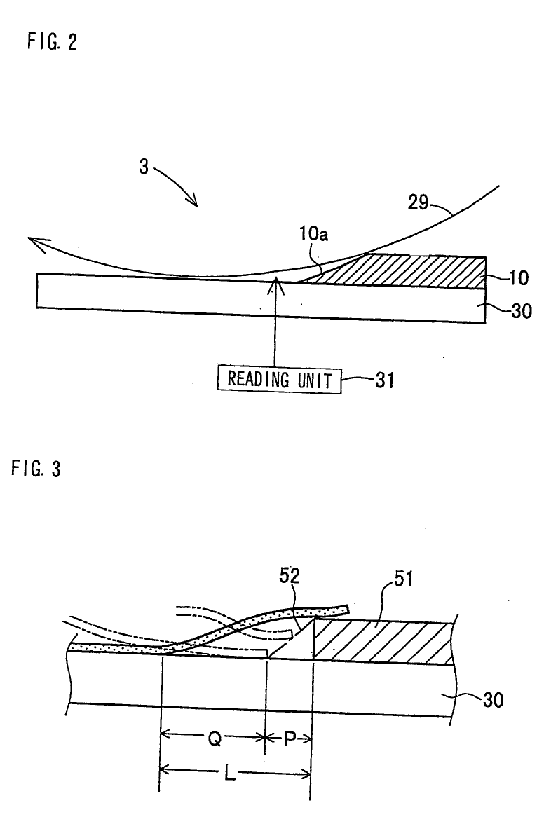

The configuration of the spacer 10 constituting the key feature of this invention will now be described. The spacer 10 is configured such that it has a sloping surface 10a that gradually becomes shorter along the downstream direction of the original document conveyance path 29, as shown in FIG. 2. The configuration of this sloping surface 10a is determined in the manner described below.

First, the case in which the conventional rectangular spacer 51 is mounted to the reading glass 30 will be considered. In this case, while the trajectory of motion traced by the part of the conveyed original document near the trailing edge thereof varies depending on the thickness and stiffness of the paper, in general it resembles the pattern shown in FIG. 3. Area L in FIG. 3 is the area over which the original document does not come into contact with the reading glass 30 when the leftmost part of the spacer 51 in the drawing is in contact with part of the original document. In the image reading apparatus 3 of the conventional art, the original document reading position is located within this area L.

At the same time, after the trailing edge of the conveyed original document moves past the spacer 51, it descends along the path traced by the trajectory line 52 in FIG. 3. As a result, the trailing edge portion of the original document does not come into contact with the reading glass 30 within the area P, but does come into contact with the surface of the reading glass 30 over the area Q. As a result, the foreign matter suspended over the area Q of the reading glass 30 is swept away from the reading glass by the original document trailing edge portion, and is in effect cleaned off of the reading glass 30 in this area. Consequently, the suspended foreign matter accumulates within the triangular area below the trajectory line 52 bounded by the spacer 51 and the reading glass 30. Accordingly, if this triangular area is added to the spacer 51 to form the spacer 10, it no longer acts as a space in which the suspended foreign matter can collect. In other words, the sloping surface 10a is configured so as to trace the trajectory line 52.

In the image reading apparatus 3 having this spacer 10, the gap between the original document conveyance path 29 and the top surface of the spacer 10 is narrow, as shown in FIG. 2. In particular, the trailing edge portion of the original document passes a position very close to the sloping surface 10a of the spacer 10. Therefore, because the area in which suspended foreign matter accumulates in the conventional art is taken up by the spacer 10, the foreign matter can no longer accumulate. The original document reading position of the image reading apparatus 3 may be placed within this area Q in FIG. 3.

As described above, according to the image reading apparatus 3 of this embodiment, because the spacer 10 has a sloping surface 10a, there is no space in which suspended foreign matter can accumulate. Therefore, the apparatus is maintenance-free, and requires no capture member or ejection member. Furthermore, because the original document reading position is placed within the area Q that is cleaned by the trailing edge portion of the original document each time the original document is read, deterioration in image quality is prevented. As a result, a compact, maintenance-free image reading apparatus 3 that prevents deterioration in image quality due to suspended foreign matter is provided.

[Second Embodiment]

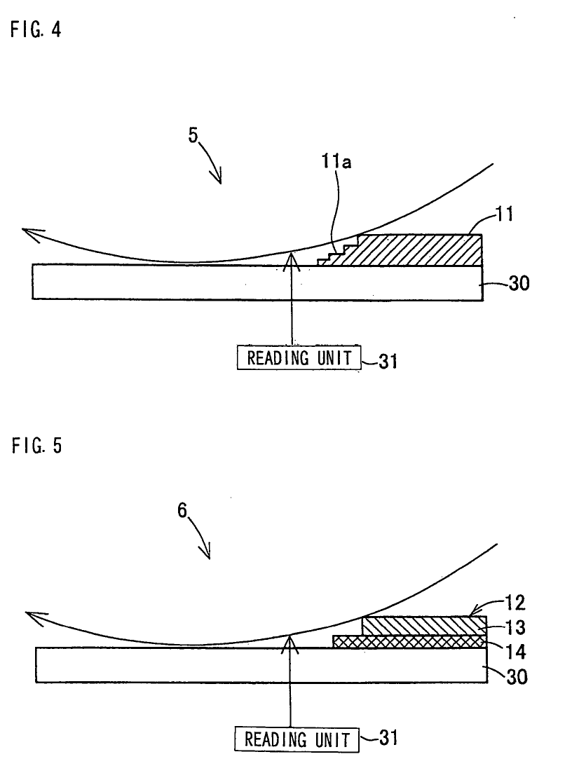

A second embodiment of the present invention will now be described in detail with reference to the drawings. The image reading apparatus 5 of this embodiment differs from the image reading apparatus 3 of the first embodiment only in regard to the configuration of the spacer 10. The spacer 11 of this embodiment has a stair-step area 11a rather than a sloping surface 10a, as shown in FIG. 4. This configuration prevents the accumulation of suspended foreign matter in the same manner as in the first embodiment. The embodiment is identical to the first embodiment in all other aspects.

As described above, the image reading apparatus 5 of the second embodiment provides a compact, maintenance-free image reading apparatus 5 that prevents deterioration in image quality due to suspended foreign matter in the same manner as the first embodiment.

[Third Embodiment]

A third embodiment of the present invention will now be described with reference to the drawings. The image reading apparatus 6 of this embodiment differs from the image reading apparatus 3 of the first embodiment only in regard to the spacer 10, and therefore the same symbols are used and further explanation is omitted.

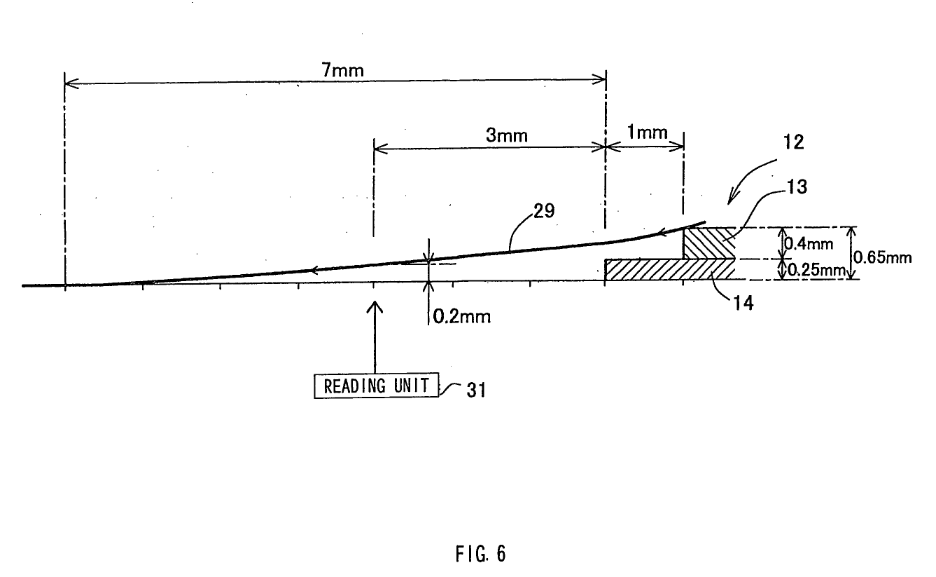

The spacer 12 of the third embodiment is composed of an upper surface member 13 and a lower surface member 14 that constitute different-sized plate-shaped members affixed together such that their distal ends are offset from one another as shown in FIG. 5. These members are disposed in a manner shown in enlargement in FIG. 6.

The size and location of each member will now be described. As shown in FIG. 6, the upper surface member 13 is a plate-shaped member having a thickness of approximately 0.4 mm, while the lower surface member 14 is a plate-shaped member having a thickness of approximately 0.25 mm. The left edge of the lower surface member 14 protrudes from beyond the upper surface member 13 by approximately 1 mm in the downstream direction. The reading position of the image reading apparatus 3 is placed approximately 3 mm from the edge of the lower surface member 14.

From experiments conducted by the inventors, it was determined that very little suspended foreign matter accumulates in the area within 0.3 mm of the original document conveyance path 29, due to air currents caused by the conveyance of the original document. Accordingly, if the original document reading position of the image reading apparatus 3 is placed at the location shown in FIG. 6, there is essentially no accumulation of suspended foreign matter at this position because the original document reading position is approximately 0.2 mm from the original document conveyance path 29. Furthermore, because the lower surface member 14 protrudes to the left of the upper surface member 13 in the drawing by 1 mm, there is very little space in which suspended foreign matter can accumulate.

The material used for the spacer 12 will now be described. Because the upper surface spacer 13 guides the original document in the direction of conveyance via contact therewith, it is preferred that it be made of a material with a low friction coefficient and good wear-resistance. For example, a film made of high-polymer polyethylene or fluorine resin would be suitable. Because these materials are relatively expensive, a more inexpensive material can be used for the lower surface member 14, for which the above performance characteristics are not required. For example, polyester film may be used. Because the spacer 12 may be formed by affixing these to films to each other so that their edges are offset, it is easy to create.

As described in detail above, according to the image reading apparatus 6 of the third embodiment, a compact, maintenance-free image reading apparatus 6 that prevents deterioration in image quality due to suspended foreign matter can be achieved in the same manner as the first embodiment.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

For example, the image reading apparatus of the above embodiments may be mounted in a standalone scanner or facsimile machine as well as a copier.

The values and materials described in connection with the third embodiment are examples only, and do not limit the present invention in any respect.

The image output engine of the image processing/formation unit 4 may be based on either the toner method or the inkjet method.

What is claimed is:

1. An image reading apparatus, comprising:
a reading transparent member;
a reading unit that reads through said reading transparent member an image on an original document that is being conveyed over an original document reading position of said reading transparent member; and
a spacer that is mounted on said reading transparent member on a surface thereof opposite the side thereof at which said reading unit is disposed and at a position upstream from the original document reading position relative to an original document conveyance direction,
wherein the spacer is configured such that height of a downstream end thereof relative to the original document conveyance direction decreases toward the downstream direction.

2. The image reading apparatus according to claim 1, wherein said spacer is configured such that the downstream end thereof comprises a downward-sloping surface whereby the height thereof decreases toward the downstream direction.

3. The image reading apparatus according to claim 1, wherein the downstream end of said spacer has a stair-step configuration, and that the height of the steps decrease toward the downstream direction.

4. The image reading apparatus according to claim 3, wherein said spacer comprises a lower surface member that comes into contact with said reading transparent member and an upper surface member that comes into contact with the original document during conveyance of the original document wherein such members are glued together to form a step configuration, and said upper surface member is made of a material having both a lower friction coefficient and superior wear-resistance than a material of said lower surface member.

5. The image reading apparatus according to claim 4, wherein thickness of said upper surface member is approximately 0.4 mm, while thickness of said lower surface member is approximately 0.25 mm.

6. The image reading apparatus according to claim 5, wherein a downstream end of said lower surface member relative to the original document conveyance direction protrudes from beyond that of said upper surface member by approximately 1 mm in the downstream direction.

7. The image reading apparatus according to claim 6, wherein said reading position is placed at a position approximately 3 mm from the downstream end of said lower surface member toward the downstream direction.

8. The image reading apparatus according to claim 7, wherein the interval between said reading transparent member and an original document conveyance path is approximately 0.2 mm at said original document reading position.

9. The image reading apparatus according to claim 4, wherein said upper surface member is formed by a film made of high-polymer polyethylene, while said lower surface member is formed by a film made of polyester.

10. The image reading apparatus according to claim 4, wherein said upper surface member is formed by a film made of fluorine resin, while said lower surface member is formed by a film made of polyester.

11. A spacer to be used for an image reading apparatus which has a reading transparent member and a reading unit that reads through said reading transparent member an image of an original document that is being conveyed over an original document reading position of said reading transparent member,
wherein said spacer is mounted on said reading transparent member on a surface thereof opposite the side thereof at which said reading unit is disposed and at a position upstream from the original document reading position relative to an original document conveyance direction,
wherein said spacer is configured such that height of a downstream end thereof relative to the original document conveyance direction decreases toward the downstream direction.
